(19) United States
(12) Patent Application Publication
(10) Pub. No.: US 2010/0057877 A1
(43) Pub. Date: Mar. 4, 2010

(54) Method for Online Game System Triggering Instant Messaging Operation and Online Game System

(76) Inventor: Rui Li, Shenzhen (CN)

Correspondence Address: MARSHALL, GERSTEIN & BORUN LLP, 233 SOUTH WACKER DRIVE, 6300 SEARS TOWER, CHICAGO, IL, 60606-6357, US

(21) Appl. No.: 12/616,132

(22) Filed: Nov. 10, 2009

(30) Foreign Application Priority Data
Jul. 13, 2007 (CN) 200710118794.1

(51) Int. Cl. G06F 15/16; A63F 9/24

(52) U.S. Cl. 709/206; 463/29

(57) ABSTRACT

A method for an online game system triggering an IM operation includes: setting a game user identification and a corresponding IM user identification in an online game server; detecting, by an online game client, whether an IM operation instruction regarding a game user identification is received, and querying for the IM user identification corresponding to the game user identification if it is determined that the IM operation instruction is received; and, invoking, by the online game client, an operation interface of an IM client, the IM user identification being taken as an invoking parameter and the operation interface corresponding to the IM operation instruction and being to trigger a corresponding IM operation. An online game system is also provided. Thereby, the IM operation can be triggered in an online game, and thus the process for triggering the IM operation is simplified and the IM client's system resources are saved.

This application claims priority to a Chinese Patent Application filed before Chinese Patent Office with Chinese Patent Application No. 200710118794.1 and Title “Method for Online Game System Triggering Instant Messaging Operation and Online Game System”, all contents of which are incorporated by reference in this application.

### FIELD OF THE INVENTION

The present invention relates to a field of network communication technology, and particularly, to a method for an online game system triggering an Instant Messaging (IM) operation and an online game system.

### BACKGROUND OF THE INVENTION

Along with fast development of network communication technology, online games, as one of leisure and entertainment ways, are accepted by more and more persons. The online games refer to electronic computer games in which multiple persons join through Internet or Local Area Network. In an existing solution, the online games are mostly implemented by an online game system. Currently, the online game system is built on a communication network, includes an online game server at network side and an online game client at terminal side. Multiple online game clients log on the online game server through the communication network accessed by the online game clients, and the online game server provides various game-running logical modules so as to control processes of the online games.

In an online game, one game user may have multiple game partners, choose a game partner and play the online game with the chosen game partner. For example, one game user may add multiple game friends, information of the multiple game friends is displayed in a friend list on a game client, and the game user may choose a game friend from the friend list and play the online game with the chosen game friend. For another example, the game user may join a game broadcast domain, i.e., a game room. In one game room, there may be multiple game users, any of which is a game partner of another, and a game user in the game room can choose any of the other game users in the same game room to play the online game with the chosen game user.

In network communication technology, an IM tool is also applied more and more widely and becomes a part of people's web life. Instant Messaging is a service system which implements communication through networks and includes an IM server based on a communication network and multiple IM clients, where, through the communication network, two or more IM clients can instantly transfer text information, files and audio and perform video communications. In an IM system, an IM user account is used to identification a user, and the user has to pass verification of the IM user account before obtaining a terminal service. Generally, the IM tool has a function of “friend list”, i.e., displays nicknames or IM user accounts of IM friends in a special area and also displays states of the IM friends, such as online, offline, busy or etc. The IM tool may further search for another IM user according to an IM user account and add the IM user account as an IM friend after confirmation. Supposing that an IM friend is in an online state, an IM client can exchange IM information with the IM friend by invoking an IM chat interface. And supposing that the IM friend is in an offline state, the IM client can also send out text information and the IM friend can see the text information when getting online next time. Through the above “friend list” function, the IM user can have multiple contacts.

### SUMMARY OF THE INVENTION

In view of the above, an embodiment of the present invention is to provide a method for an online game system triggering an Instant Messaging (IM) operation, which realizes triggering the IM operation in an online game, simplifies the process of triggering the IM operation and saves system resources of IM client.

Another embodiment of the present invention is to provide an online game system, which realizes triggering an IM operation in an online game, simplifies the process of triggering the IM operation and saves system resources of IM client.

According to an embodiment of the present invention, a method for an online game system triggering an Instant Messaging (IM) operation includes: setting a game user identification and a corresponding IM user identification in an online game server; and, the method including: detecting, by an online game client, whether an IM operation instruction regarding a game user identification is received, and querying for the IM user identification corresponding to the game user identification if it is determined that the IM operation instruction is received; and, invoking, by the online game client, an operation interface of an IM client, the IM user identification being taken as an invoking parameter and the operation interface corresponding to the IM operation instruction and being to trigger a corresponding IM operation.

The method further includes: obtaining, by the online game client, from the online game server game user identifications of all game partners of a local game user and IM user identifications corresponding to the game user identifications, and caching the obtained information in local.

In the above solution, said querying for the IM user identification corresponding to the game user identification specifically includes: sending, by the online game client, to the online game server a query request including the game user identification being regarded by the IM operation instruction; and, querying, by the online game server, for the IM user identification corresponding to the game user identification, and sending a query result to the online game client.

The method further includes: popping up, by the online game client, a rich window when a friend identification in a friend list is activated; and, obtaining, by the rich window, the IM operation instruction.

In the above solution, the operation interface is a Component Object Model (COM) component interface.

In the above solution, the IM operation instruction is an operation instruction for adding an IM friend or an operation instruction for having an IM chat.

According to an embodiment of the present invention, an online game system includes: an online game client and an Instant Messaging (IM) client, the online game client comprising an IM operation instruction detecting module, an IM user identification query module and an operation interface invoking module; the online game server being adapted to store game user identifications and IM user identifications corresponding to the game user identifications; the IM operation instruction detecting module being adapted to detect whether an IM operation instruction regarding a game user identification is received, and start up the IM user identification query module if the IM operation instruction regarding the game user identification is received; the IM user identification query module being adapted to query for the IM user identification corresponding to the game user identification; and, the operation interface invoking module being adapted to invoke an IM operation interface of an IM client, the IM user identification being taken as an invoking parameter and the IM operation interface corresponding to the IM operation instruction and being to trigger a corresponding IM operation.

In the above solution, the online game client further includes: an information storing module, adapted to obtain from the online game server game user identifications of all game partners of a local game user and IM user identifications corresponding to the game user identifications and cache the obtained information.

In the above solution, the online game client further includes: an IM operation instruction obtaining module, adapted to pop up a rich window when a friend identification in a friend list is activated, the rich window obtaining the IM operation instruction.

In the above solution, the rich window includes a button for adding an IM friend and a button for having an IM chat; the button for adding an IM friend being adapted to obtain an operation instruction for adding an IM friend, and the button for having an IM chat being adapted to obtain an operation instruction for having an IM chat.

### BRIEF DESCRIPTION OF THE DRAWINGS

FIG. 1 is a schematic diagram illustrating how to input an IM operation instruction to a game friend list.

FIG. 2 is a schematic diagram illustrating how to input an IM operation instruction to a game room.

FIG. 3 is a flowchart illustrating a method for an online game system triggering an IM operation according to an embodiment of the present invention.

FIG. 4 is a schematic diagram illustrating a structure of the online game system according to an embodiment of the present invention.

### DETAILED DESCRIPTION OF THE INVENTION

The present invention will be described in detail with reference to embodiments and accompanying drawings.

Along with the popularization of the online games and the IM tool, many users have both online game user accounts and IM user accounts simultaneously, and thus there is a requirement of performing Instant Messaging with game partners while playing an online game. However, in the prior art, the online game system and the IM system are separate from each other and do not have a direct relation between them. Therefore, if a user needs to perform the Instant Messaging with a game partner while playing the online game, the user needs to perform the following:

a. Obtaining the IM user account of the game partner first. This process requires manual participation, that is, the game partner notifies the user of his/her own IM user account, or the game partner registers his/her own IM user account at a certain position in the network and the user searches for this IM user account manually.

b. After obtaining the IM user account of the game partner, the user logs on his/her own IM client to manually input the IM user account of the game partner to the IM client and to manually add the IM user account as an IM friend, and then manually initiates a chat with the IM friend.

Inventor finds that, in the prior art, the online game system and the IM system have no connection, and when the user wants to perform Instant Messaging with the game partner while playing the online game, the user needs to first obtain the IM user account of the game partner manually and then start up the IM system. The whole procedure is complicated and occupies system resources of the IM client, and thereby its processing efficiency is low.

According to an embodiment of the present invention, a game user identification and an IM user identification corresponding to the game user identification are configured in an online game server, and the method for an online game system triggering an IM operation includes:
A. An online game client detects whether an IM operation instruction with regard to a game user identification is received from outside;
B. After detecting an IM operation instruction, the online game client queries for an IM user identification corresponding to the game user identification which the IM operation instruction is with regard to; and,
C. The online game client takes the IM user identification obtained by query as an invoking parameter to invoke an operation interface of an IM client, and the operation interface corresponds to the IM operation instruction and is used to trigger a corresponding IM operation.

In an embodiment of the present invention, the game user identification may be identification information such as a game user account or a game user nickname; the IM user identification may be an IM user account. The game user identification mainly refers to identifications of game partners of a local game user. The game partners may be game friends of the local game user or other game users in one game broadcast domain which the local game user joins in. One game broadcast domain refers to one game room, and all game users joining in the game room are game partners with each other. The identifications of the game friends are displayed in a game friend list at the game client, and identifications of the game users in one game room are displayed on an interface of the game room.

The IM operation instruction in an embodiment of the present invention is an operation instruction sent for a game user identification at an online game client, for example, an operation instruction for adding a game partner as an IM friend or for having an IM chat with a game partner. The operation instruction may be inputted in a variety of manners.

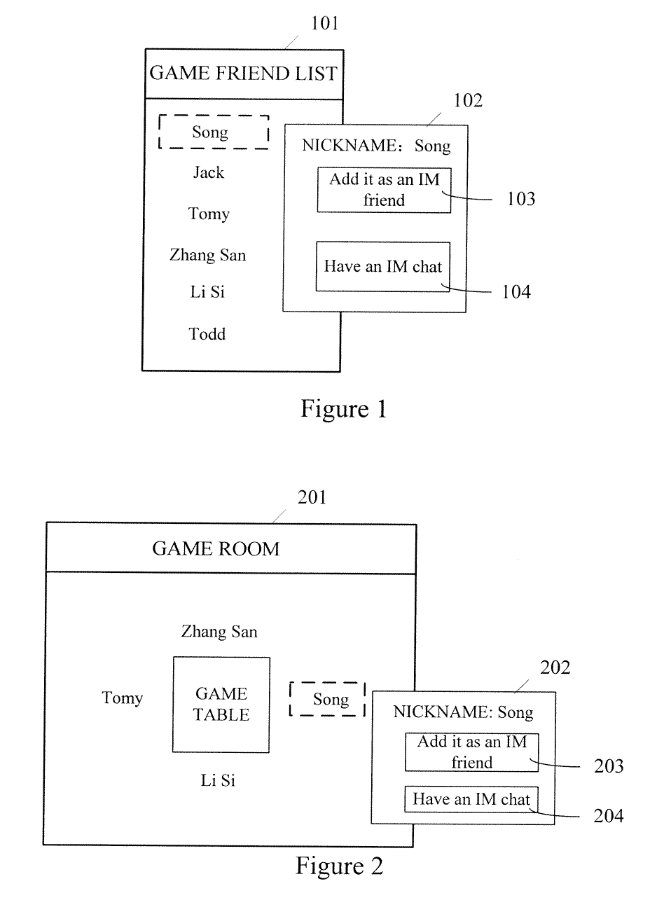

FIG. 1 is a schematic diagram illustrating a manner for inputting an IM operation instruction. As shown in FIG. 1, prompt information of operation instruction may be configured in a game friend list 101, and when a user clicks a friend identification in the game friend list 101 (e.g., clicks game friend Song as shown in FIG. 1), a game client pops up a rich window 102. The rich window 102 includes two operation buttons, one is a button 103 for adding an IM friend and the other is a button 104 for having an IM chat. The window of the rich window can display rich data and status information of a special user or group besides its basic information. The basic information is generally regarded as basic attributes of the user or group, such as the use's user name, nickname, age and etc. More rich data may be online game information or status information of the user, and the status information includes information indicating online, offline, current operation or etc. The rich window may further include some controls such as toolbars, buttons, hyperlinks and menus, and a particular operation can be performed by clicking the controls.

When the user clicks the button 103 therein, an IM operation instruction for adding an IM friend is sent out, where the IM operation instruction contains the user identification of game friend Song in order to add game friend Song as an IM friend. And, when the user clicks the button 104, an IM operation instruction for having an IM chat is sent out, where the IM operation instruction contains the user identification of game friend Song in order to have IM-chat communications with the IM client of game user Song.

FIG. 2 is a schematic diagram illustrating another manner for inputting an IM operation instruction. With reference to FIG. 2, prompt information of operation instruction is set in a game room which a local game user joins in. The game room as shown in FIG. 2 includes a game table around which four game user identifications are displayed. Supposing that the local game user is Zhang San, when Zhang San hopes to perform an IM operation to game user Song, Zhang San may click game user Song, and then, a game client pops up a rich window 202. The rich window 202 includes two operation buttons where one is a button 203 for adding an IM friend and the other is a button 204 for having an IM chat. When a user clicks the button 203 therein, an IM operation instruction for adding an IM friend is sent out, and the IM operation instruction contains the user identification of game friend Song in order to add game friend Song as an IM friend. When the user clicks the button 204 therein, an IM operation instruction for having an IM chat is sent out, and the IM operation instruction contains the user identification of game friend Song in order to have IM-chat communications with the IM client of game user Song.

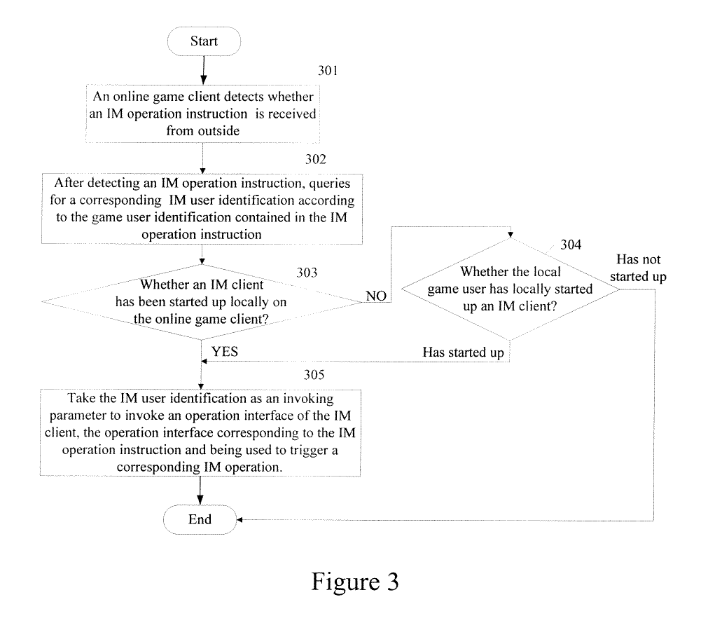

FIG. 3 is a flowchart illustrating a method for an online game system triggering an IM operation according to an embodiment of the present invention. With reference to FIG. 3, the method includes:

Step 301: An online game client detects whether an IM operation instruction with regard to a game user identification is received from outside, for example, detects whether a user clicks the buttons 103, 104, 203 or 204 to input an IM operation instruction.

Step 302: After detecting the IM operation instruction, the online game client queries for an IM user identification corresponding to the game user identification which the IM operation instruction is with regard to, i.e., queries for the IM user identification according to the game user identification contained in the IM operation instruction. Supposing that an IM operation is with regard to game user Song, the IM operation instruction contains a game user identification of Song, and the online game client queries for the IM user identification corresponding to the game user identification of Song.

Herein, there may be two query methods:

In a first query method, when the online game client initially logs on an online game server and passes user verification, the online game client obtains game user identifications of all game partners of a local game user as well as IM user identifications corresponding to these game user identifications, and caches the obtained information in local. For example, when the local game user logs on the online game server, the local game user obtains from the online game server the game user identifications of all game friends as well as the IM user identifications corresponding to these game user identifications and caches them locally; and, when the local game user enters a certain game room, the local game user obtains from the online game server the game user identifications of all game users in the game room as well as the IM user identifications corresponding to the game user identifications. After detecting the IM operation instruction, the online game client queries according to the game user identification contained in the IM operation instruction for the IM user identification corresponding to this game user identification from the locally-cached information. In the first query method, the query is facilitated because the information is cached locally in advance.

In a second query method, after detecting the IM operation instruction, the online game client sends to the online game server a query request containing the game user identification which the IM operation instruction is with regard to, and the online game server queries for the IM user identification corresponding to the game user identification and sends a query result to the online game client.

Information interaction between the online game client and the online game server may be implemented by a Transfer Control Protocol (TCP).

Step 303: Whether an IM client has been started up locally on the online game client is determined, if it has been started up, Step 305 is performed, and otherwise, Step 304 is performed.

Step 304: The local game user is prompted to locally start up an IM client, and whether the IM client has been locally started up is determined, if it has been started up, Step 305 is performed, and otherwise, the IM client is started up and the procedure is terminated if the IM client can not be started up in a predetermined period of time.

Step 305: The IM user identification obtained by query is taken as an invoking parameter to invoke an operation interface of the local IM client. The operation interface corresponds to the IM operation instruction and is used to trigger a corresponding IM operation.

In an embodiment of the present invention, the IM client needs to provide an operation interface that can be invoked by the outside. In an embodiment, communications between the online game client and the IM client is realized by COM (Component Object Model) component invoking and the operation interface provided by the IM client is a COM component interface, where the COM component interface includes an operation interface for adding an IM friend and an operation interface for having an IM chat, the invoking parameter of which is the IM user identification, and specifically, is an IM user account.

When the IM operation instruction is the operation instruction for adding an IM friend, a corresponding operation interface of the IM client invoked by the online game client is the operation interface for adding an IM friend, and through the operation interface for adding an IM friend, the IM client is triggered to add the IM user account (e.g., the IM user account of the user Song) as a friend of the local IM client.

When the IM operation instruction is the operation instruction for having an IM chat, a corresponding operation interface of the IM client invoked by the online game client is the operation interface for having an IM chat, and through the operation interface for having an IM chat, the IM client is triggered to have an IM chat with the IM user account, e.g., the IM user account of the user Song.

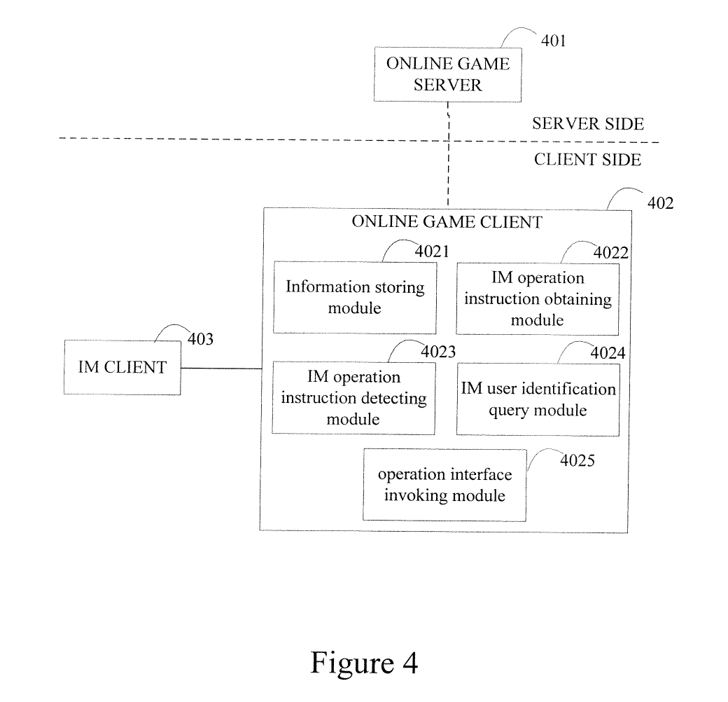

FIG. 4 is a schematic diagram illustrating a structure of an online game system according to an embodiment of the present invention. The online game system is improved based on an existing online game system, and has components and functions of the existing online game system. Hereinafter, the components and the functions of the existing online game system will not be described again while only improvements to the existing online game system are described below.

With reference to FIG. 4, the online game system according to an embodiment of the present invention includes: an online game server 401, an online game client 402 and an IM client 403. Besides the functions of an existing online game server, the online game server 401 further stores game user identifications and IM user identifications corresponding to the game user identifications. The online game client 402 is connected respectively to the online game server 401 and the IM client 403 in local. Therein, the online game client 402 includes an information storing module 4021, an IM operation instruction obtaining module 4022, an IM operation instruction detecting module 4023, an IM user identification query module 4024 and an operation interface invoking module 4025.

The information storing module 4021 obtains from the online game server 401 in advance game user identifications of all game partners of a local game user as well as IM user identifications corresponding to the game user identifications, and caches the obtained information locally.

The IM operation instruction obtaining module 4022 pops up a rich window when a friend identification in a friend list is activated. The rich window includes a button for adding an IM friend and a button for having an IM chat. When the button for adding an IM friend is activated, an operation instruction for adding an IM friend is generated; and, when the button for having an IM chat is activated, an operation instruction for having an IM chat is generated.

After detecting the IM operation instruction, the IM operation instruction detecting module 4023 starts up the IM user identification query module 4024.

The IM user identification query module 4024 queries the information storing module 4021 for the IM user identification, and transfers the IM user identification to the operation interface invoking module 4025.

The operation interface invoking module 4025 takes the IM user identification obtained by query to invoke an IM operation interface of the IM client 403. In the online game system according to an embodiment of the present invention, the IM client 403 needs to provide an operation interface that can be invoked by the outside. In this embodiment, the communication between the online game client 402 and the IM client 403 is realized by COM component invoking, and the operation interface provided by the IM client 403 is a COM component interface which includes an operation interface for adding an IM friend and an operation interface for having an IM chat, where the invoking parameter is the IM user identification, and more specifically, is an IM user account.

When the IM operation instruction is the operation instruction for adding an IM friend, a corresponding operation interface of the IM client 403 invoked by the operation interface invoking module 4025 is the operation interface for adding an IM friend. Through the operation interface for adding an IM friend, the IM client 403 is triggered to add the IM user account (e.g., the IM user account of the user Song) as a friend of the local IM client 403.

When the IM operation instruction is the operation instruction for having an IM chat, a corresponding operation interface of the IM client 403 invoked by the operation interface invoking module 4025 is the operation interface for having an IM chat. Through the operation interface for having an IM chat, the IM client 403 is triggered to have an IM chat with the IM user account, e.g., the IM user account of the user Song.

According to embodiments of the present invention, the game user identification and the corresponding IM user identification are stored in the online game server in advance, and when a user needs to perform an IM operation for the game user identification, e.g., adding a game partner as an IM friend or having an IM chat with a game friend, the user finds the IM user identification corresponding to the game user identification and directly invokes an operation interface of the IM client according to the IM user identification so as to complete the IM operation. Therefore, compared with the prior art, when performing an IM operation according to the present invention, it is not necessary either to manually query for the IM user identification of a game partner or to perform a complicated IM operation at the IM client, so that an automatic IM operation is realized, and thus redundant occupation of system resources of IM client when the IM client performs the IM operation is avoided, the system resources of client are saved, processing efficiency of client's system is raised, and at the same time, the user's operation steps are simplified the accuracy of which is also raised, and the user is enabled to complete the IM operation faster and more accurately during the online game.

In an embodiment of the present invention, the online game client may download game partners' user identifications as well as their IM user identifications from the online game server and cache them in local in advance, and when it is needed to query an IM user identification, the IM user identification can be queried from local, thereby not only the query speed can be sped up, but also network resources are saved.

The foregoing is only preferred embodiments of the present invention. The protection scope of the present invention, however, is not limited to the above disclosure. Any change or substitution within the range of the technical disclosure in the present invention, easily occurring to those skilled in the art, should be covered by the protection scope of the present invention.

1. A method for an online game system triggering an Instant Messaging (IM) operation, characterized by, setting a game user identification and a corresponding IM user identification in an online game server; and,
the method comprising:
detecting, by an online game client, whether an IM operation instruction regarding a game user identification is received, and querying for the IM user identification corresponding to the game user identification if it is determined that the IM operation instruction is received; and,
invoking, by the online game client, an operation interface of an IM client, the IM user identification being taken as an invoking parameter and the operation interface corresponding to the IM operation instruction and being to trigger a corresponding IM operation.

2. The method of claim 1, characterized by, further comprising:
obtaining, by the online game client, from the online game server game user identifications of all game partners of a local game user and IM user identifications corresponding to the game user identifications, and caching the obtained information in local.

3. The method of claim 1, characterized by, said querying for the IM user identification corresponding to the game user identification comprising:
sending, by the online game client, to the online game server a query request comprising the game user identification being regarded by the IM operation instruction; and,
querying, by the online game server, for the IM user identification corresponding to the game user identification, and sending a query result to the online game client.

4. The method of claim 1, characterized by, further comprising:
popping up, by the online game client, a rich window when a friend identification in a friend list is activated; and,
obtaining, by the rich window, the IM operation instruction.

5. The method of claim 1, characterized by, the operation interface being a Component Object Model (COM) component interface.

6. The method of claim 1, characterized by, the IM operation instruction being an operation instruction for adding an IM friend or an operation instruction for having an IM chat.

7. An online game system, comprising: an online game client and an Instant Messaging (IM) client, characterized by,
the online game client comprising an IM operation instruction detecting module, an IM user identification query module and an operation interface invoking module;
the online game server being adapted to store game user identifications and IM user identifications corresponding to the game user identifications;
the IM operation instruction detecting module being adapted to detect whether an IM operation instruction regarding a game user identification is received, and start up the IM user identification query module if the IM operation instruction regarding the game user identification is received;
the IM user identification query module being adapted to query for the IM user identification corresponding to the game user identification; and,
the operation interface invoking module being adapted to invoke an IM operation interface of an IM client, the IM user identification being taken as an invoking parameter and the IM operation interface corresponding to the IM operation instruction and being to trigger a corresponding IM operation.

8. The online game system of claim 7, characterized by, the online game client further comprising: an information storing module, adapted to obtain from the online game server game user identifications of all game partners of a local game user and IM user identifications corresponding to the game user identifications and cache the obtained information.

9. The online game system of claim 7, characterized by, the online game client further comprising: an IM operation instruction obtaining module, adapted to pop up a rich window when a friend identification in a friend list is activated, the rich window obtaining the IM operation instruction.

10. The online game system of claim 9, characterized by, the rich window comprising a button for adding an IM friend and a button for having an IM chat;
the button for adding an IM friend being adapted to obtain an operation instruction for adding an IM friend, and
the button for having an IM chat being adapted to obtain an operation instruction for having an IM chat.
